(19) United States
(12) Patent Application Publication
(10) Pub. No.: US 2022/0364689 A1
(43) Pub. Date: Nov. 17, 2022

(54) LAMP WITH DYNAMIC LENS CONTROL

(71) Applicant: Koehler-Bright Star LLC, Hanover Township, PA (US)

(72) Inventors: Walter Kaihatu, Salt Lake, UT (US); Thomas Pellegrini, Exeter, PA (US)

(21) Appl. No.: 17/687,825

(22) Filed: Mar. 7, 2022

Related U.S. Application Data
(60) Provisional application No. 63/186,956, filed on May 11, 2021.

(51) Int. Cl. F21L 4/08; F21L 4/02; F21V 23/04; F21V 9/40

(52) U.S. Cl. CPC F21L 4/085; F21L 4/027; F21V 23/0442; F21V 9/40; F21Y 2115/10

(57) ABSTRACT

A lighting device includes a housing, a power supply, a first light source such as a LED, a variable focus lens adapted to vary the focus of light from the first light source, a switch and a controller having circuitry, The circuitry is adapted to control the current to the first light source based upon a voltage of the power supply, and is adapted to control variability of the variable focus lens.

### CROSS-REFERENCE TO RELATED APPLICATION DATA

This application claims the benefit of and priority to Provisional U.S. Patent Application Ser. No. 63/186,956, filed May 11, 2021, titled LAMP WITH DYNAMIC LENS CONTROL, the disclosure of which is incorporated herein in its entirety.

### BACKGROUND

The present disclosure relates a portable lamp or lighting device, and more particularly, a portable lamp with dynamic lens control.

Lighting devices, such as flashlights and cap lamps are typically designed to have either a central light to produce a central beam pattern or a peripheral light or lights to produce a peripheral beam pattern. A central beam pattern is typically used for illuminating objects at relatively far distances. A peripheral beam pattern is typically used for shorter distances, and wider field-of-view applications. A peripheral beam pattern typically provides softer light, less eye strain and better peripheral lighting than the central beam pattern. Accordingly, where needs and environments may vary, a user may carry multiple lighting devices having different lighting configurations to produce central beam patterns or peripheral beam patterns as needed.

For example, a firefighter may need a highly focused central beam pattern when inside of a fire with thick smoke. However, a peripheral beam pattern may be more suitable when working in areas around the fire scene, for instance, to identify potential obstacles in areas which are otherwise poorly illuminated. In another example, a utility worker may need to a see a transformer at night that is far away, thus requiring a lighting device configured to produce a central beam. However, when performing maintenance or repair, the utility worker may need a softer, more diffuse light, such as the light provided by a peripheral beam pattern.

However, the need for using multiple lighting devices results in increased equipment costs. In addition, carrying multiple lighting devices at a job site may be burdensome or cumbersome to the user. Further, switching between lighting devices may be time consuming.

Keisling, U.S. Pat. No. 9,933,122 (“US '122”) provides a lighting device providing both central and peripheral illumination to produce a balanced light beam pattern. To this end, US '122 provides a light assembly having a light source and a reflector having a reflective interior surface and a central opening. A toroidal-shaped toroid optic includes a central bore and the light source is positioned in the central bore. The toroid optic is positioned within the central opening of the reflector. A broadening lens is attached to the reflector and positioned adjacent to the toroid optic. The broadening lens includes a central optic. While the lighting device of US '122 provides a balance between central and peripheral illumination, the beam pattern is fixed for a given optic design. US '122 is commonly assigned with the instant application and is incorporated herein by reference, in its entirety.

Other known lighting devices include mechanical adjustments to adjust optic components relative to the position of the light source in order to vary the beam pattern. Such mechanical adjustments include sliding or screwing mechanisms. However, the mechanical adjustments add complexity to the lighting device, and are limited in the amount of peripheral light which may be obtained. Other known lighting devices include electronically adjustable lenses configured to focus light without requiring mechanical movement of the lens itself. One such lens includes a crystalline orientation which may be varied in response to application of a voltage. Another lens, referred to as a liquid lens, includes an optical liquid material that can change shape to vary the focal length. For example, a radius of curvature of the liquid lens may be electronically controlled to vary the focal length through electrowetting or the use of shape changing polymers. However, such known lighting devices may not be portable, and/or the lenses may be relatively complex to produce and install.

Still another device disclosed in Keisling, et al., U.S. Publication 2020/0088369 (“US Pub. '369”) discloses an electronically variable lighting device having first and second light sources and circuitry interconnecting a power supply, input device and the light sources. The light sources produce a light beam shape for producing a light beam pattern. While the device disclosed in US Pub. '369 functions well to shape the beam pattern, it lacks the capability to adjustably focus a beam for both short (flood) and long (spot) distance viewing.

Accordingly, it is desirable to provide a lighting device configured to provide a portable lamp with a user selectable variable focused light beam. Desirably, such a lamp has a beam angle that can be varied focus from about 1.5 degrees to about 50 degrees.

### SUMMARY

According to one embodiment a lighting device includes a housing, a power supply, a first light source, such as a LED, Laser Excited Phosphor (LEP) or like suitable light sources, and a variable focus lens adapted to vary the focus of light from the first light source. In embodiments, the first light source is a forward light source. In embodiments, the power supply is a portable, such as a rechargeable power supply, such as one or more batteries.

The lighting device further includes a switch and a controller having circuitry that is adapted to control the current to the first light source based upon a voltage of the power supply, and is adapted to control variability of the variable focus lens. The variable focus lens shapes a beam from the light source between about 15 degrees and 55 degrees.

In an embodiment, the variable focus lens is a liquid crystal controllable lens. In embodiments in which the variable focus lens has a non-linear broadening angle profile, the control circuitry is adapted to convert the non-linear broadening angle profile to a linear broadening angle profile.

The lighting device can also include one or more second light sources, such as one or more rear lights.

In embodiments the power source has a peak voltage of greater than about 7.4V and likely about 8.2V. When a voltage from the power source is between about peak, or about 7.4V and 6V, the circuity regulates current from the power source to about 1A, and when the voltage from the power source is less than about 6V, the circuity regulates the current from the power source to about 500 mA.

The lighting device can further include a power source level indicator, such that when the voltage is greater than about 7.4V, the power source level indicator indicates full power, when the voltage is between about 7.4V and 6V, the power source level indicator indicates mid-level power and when the voltage is less than about 6V, the power source level indicator indicates low power.

In embodiments, the lighting device further includes one or more temperature sensors. The temperature sensors can include a PCB temperature sensor and/or a forward light source temperature sensor and/or a power source temperature sensor. In an embodiment, the temperature sensors include a PCB sensor, a forward light source temperature sensor and a power source temperature sensor.

The lighting device can be configured such that when the current to the forward light source is about 1A and the forward light source temperature sensor senses a temperature of greater than about 70° C., current to the forward light source is reduced to 90 percent. The device can be further configured such that when the current to the forward light source is about 500mA and the forward light source temperature sensor senses a temperature of greater than about 80° C., current to the forward light source is reduced to 50 percent.

Further still, in embodiments, the lighting device can be configured such that charging of the battery is suspended when the power source temperature sensor senses a temperature greater than about 50° C., and charging resumes when the battery temperature sensor senses a temperature less than about 45° C.

In embodiments, the switch controls power to the first light source and controls variability of the variable focus lens.

The present lighting device has a luminous intensity of about 450,000 candela and a beam distance of over 4,400 feet (over 1300 meters), and the ability to cast a beam to the top of a building over 300 stories. At 25 feet the lighting device in flood beam mode can produce sufficient light to illuminate a ladder truck in light.

The lighting device has a run time of about 4 hours and a charge time of about 4 hours. The variable focus spot to flood is about a 1.5 degree to about 50 degree beam angle.

These and other features and advantages of the present invention will be apparent from the following detailed description, in conjunction with the appended claims.

### BRIEF DESCRIPTION OF THE DRAWINGS

FIG. 1A is a top perspective view of an example of a lighting device having a lamp with dynamic lens control according to an embodiment;

FIG. 1B is a rear view of an example of a lighting device;

FIG. 2A is an exploded view of an embodiment of a forward light assembly;

FIG. 2B is a cross-sectional view of the forward light assembly;

FIG. 3 illustrates a general layout of a circuit board for the lighting device;

FIG. 4 illustrates a layout of the forward light source and circuit board for the forward light source;

FIG. 5 illustrates an example of a lens having dynamic lens control;

FIG. 6 is a schematic of a typical thermocouple;

FIG. 7 is a plot of the battery over current protection algorithm;

FIG. 8 is a plot of the blip (flash) indication for battery voltage level change;

FIG. 9 is a plot of the lookup index vs. dynamic lens broadening angle;

FIG. 10 is a plot of the lookup index vs. dynamic lens voltage for linear focus adjustment;

FIG. 11 is a plot showing the voltage, current to forward light source, and current drawn from the battery to 100 percent battery discharge;

FIG. 12 is a plot of the dynamic lens broadening angle vs. voltage before adjustment for linear focus;

FIG. 13 is a photograph of the lighting device shown with a narrow angle or spot focus; and

FIG. 14 is a photograph of the lighting device shown with a wide angle or flood focus.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

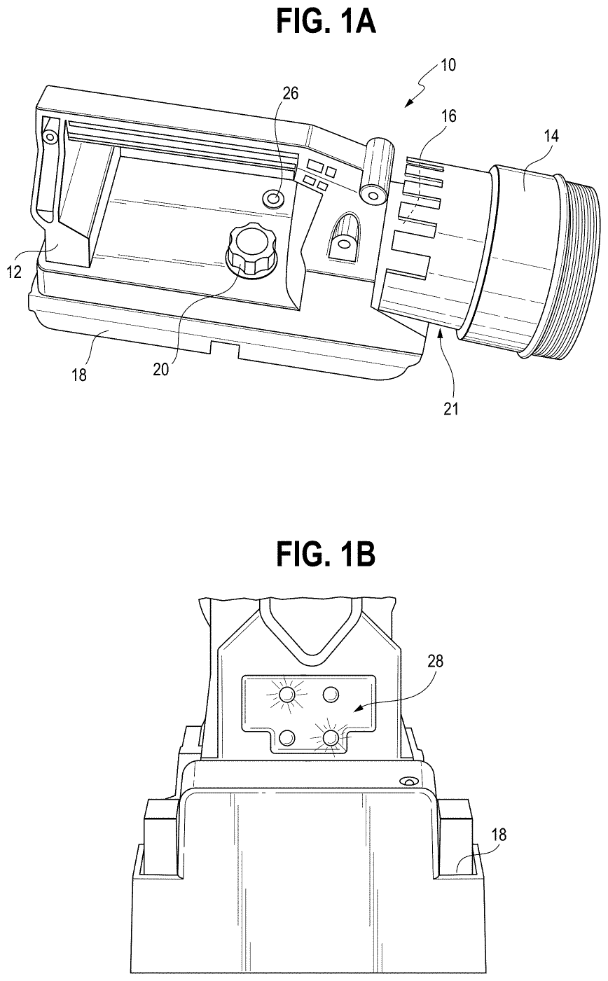

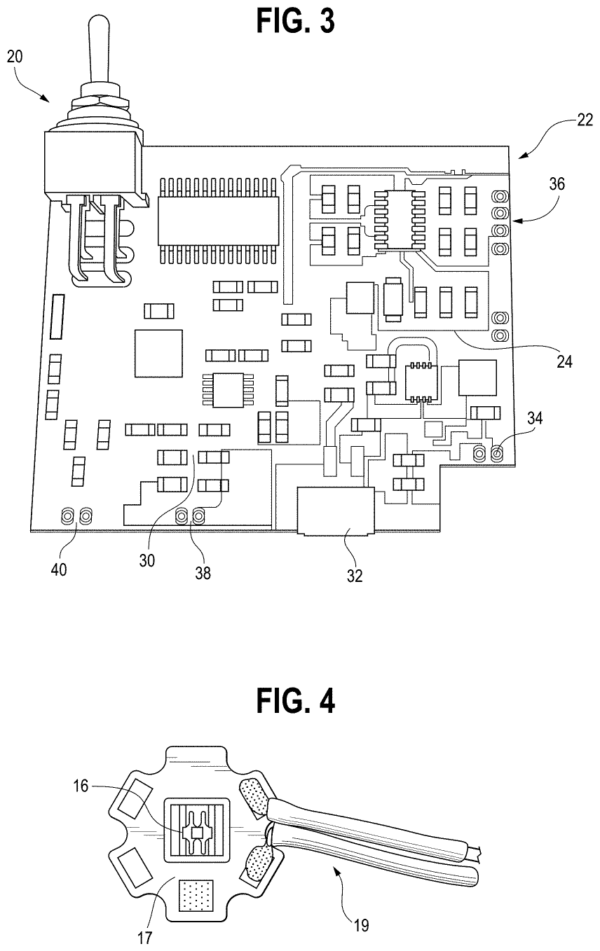

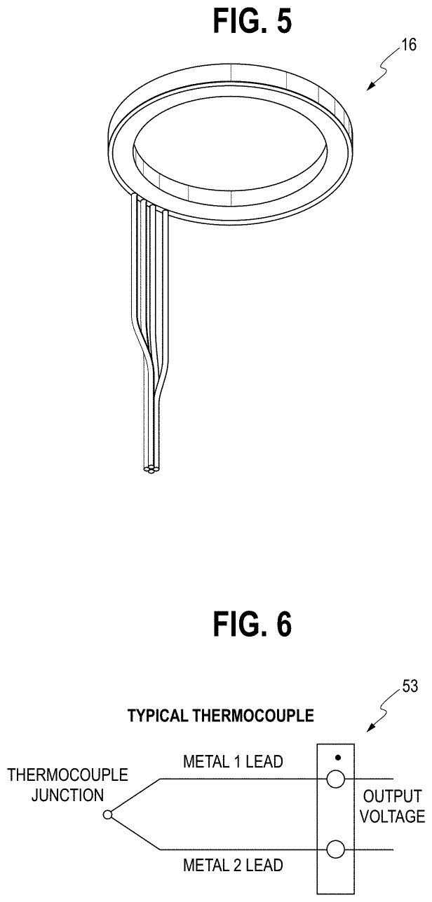

FIGS. 1A and 1B illustrate an example of a lighting device 10 having dynamic lens control according to an embodiment. The device includes a housing 12, a lens 14, at least one light source 16, at least one power supply 18, a switch 20, and a printed circuit board (PCB) 22 that includes the lighting device controls 24 (see also FIG. 3). The lighting device can also include a battery level indicator 26.

In an embodiment, the lighting device 10 has multiple light sources, including one front or forward light source 16, such as a white light source and one or more rear light sources 28, for example, one or two red light sources and one or two white light sources.

In a current embodiment, the front or forward light source 16 is a laser light, such as a 910-00003 LaserLight, rated at 8.7V at 1.65A, nominal LED, Laser Excited Phosphor (LEP) or like suitable light source, which light source is commonly commercially available. One suitable forward light source 16 has two modes, a high mode and a low mode. Current for the high mode is about 1.5A at 9V and for the low mode about 1.0A at 9V. FIG. 4 illustrates one example of an LED/LEP forward light source 16 and its associated printed circuit board (LED PCB) 17 and a pair of conductors 19 connected to the LED PCB 17. For purposes of the present disclosure, reference to forward light source, LED and LEP is to be understood to encompass all of the noted light sources, as well as not yet known, but suitable light sources.

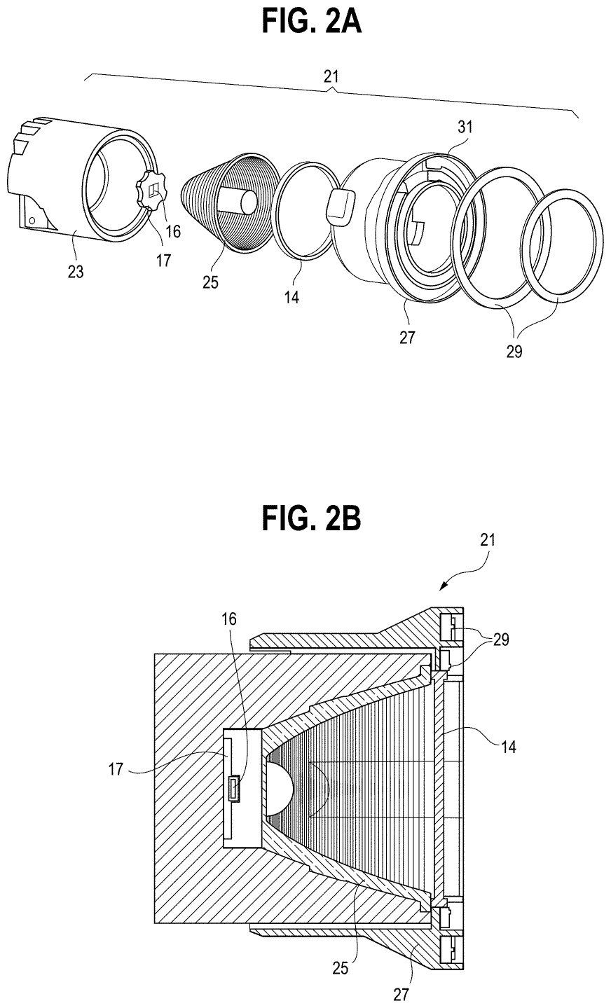

Referring to FIGS. 2A and 2B, in an embodiment, the forward light source 16 is housed within a forward light assembly 21. The assembly 21 includes an optical housing 23, the forward light source 16, a reflector 25, the lens 14, a head cover 27 and optionally, one or more forward flood lights 29. The optional forward flood lights 29 can be positioned around a periphery 31 of the head cover 27. The reflector 25 can be, for example, a TIR optic or TIR lens.

In an embodiment, the lighting device 10 includes a power supply, such as a portable, rechargeable power supply, for example, two power sources 18, such as two battery packs. Suitable battery packs 18 include 2S2P (2 cells in series and the 2 series of cells in parallel) and 2S3P battery packs. The battery packs 18 are rated at 5200 mAh and 7800 mAh, respectively, at 8.3V. It is contemplated that line voltage that is appropriately attenuated can also be used. Various operating modes and operator notifications are provided as described below.

The lighting device PCB 22 includes circuitry 30 to control the device. In an embodiment the control circuitry is contained on the PCB 22 and the LED PCB 17. Referring to FIG. 3, an example of a circuit board 22 includes components for battery input connections and control 32, components for the forward light source output connections and control 34, components for dynamic lens control connections and control 36, components for charging connections and control 38 and components for rear light source connections and control 40. The circuit board 22 also includes charging indicator connections and control (not shown), and is shown with the switch 20.

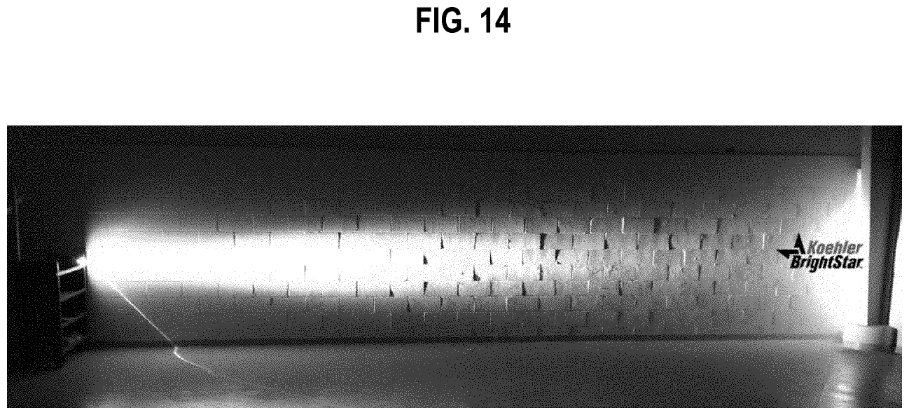

The lighting device 10 uses a variable focus or dynamic lens 14, such as a liquid crystal, controllable lens that permits a beam from the front light source 16 to be dynamically shaped. Referring briefly to FIGS. 13 and 14, the beam can be shaped or focused from about 15 degrees to provide narrow spot beam illumination (FIG. 13) to about 55 degrees to wide flood beam illumination (FIG. 14). One such lens is a LENSVECTOR™ lens, commercially available from LensVector of San Jose, Calif.

In an embodiment, with the 8.3V battery input voltage and a 9.1V LED forward voltage, it was found that a boost circuit is required. With boost circuits, as the battery voltage decrease the current drawn from the battery increases. A voltage based algorithm is used to decrease the forward light source current to limit the times the over current protection activates when the battery still has usable energy.

To determine the voltage levels, measurements were taken of a lighting device 10 at different voltages and the current measured from the supply was recorded. The forward light source load was chosen with a higher forward voltage to represent a more severe current usage scenario. The values were plotted against the protection IC over current protection specification. From this result, the trip voltages were selected as indicated in Table 1, below.

TABLE 1
Allowed Current in Forward Light Source

| | | | |
|---|---|---|---|
| | | Current | Battery Level |
| Levels | Voltage | allowed in LED | indication LED |

| Level 0 | >7.4 | V | Restricted | | Green |
|---|---|---|---|---|---|
| | | | by design | | |
| Level 1 | >6 | v | ~1 | A | Orange |
| Level 2 | <6 | v | ~500 | mA | Red |

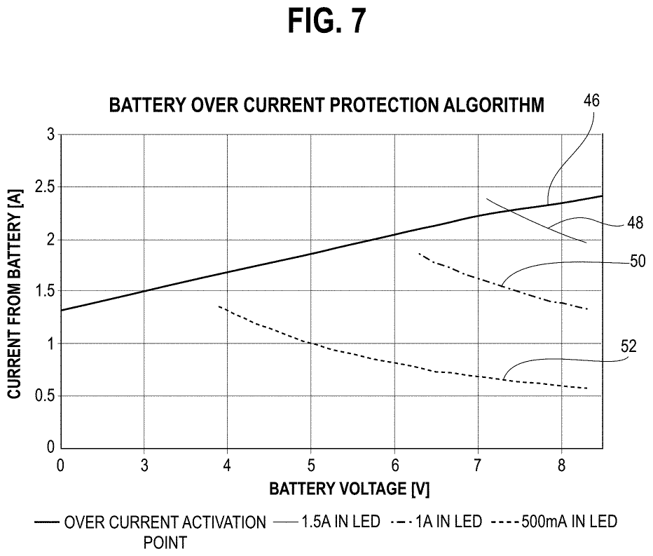

FIG. 7 is a plot of the battery overcurrent protection algorithm and plots the battery current in amps (A) versus the battery voltage in volts (V). The curve indicated at 46 represents the theoretical worst case current at which the over current protection integrated circuit (IC) will activate. The curve indicated at 48 represents the measured current at specific voltages for 1.5A in the forward light source, the curve indicated at 50 represents the measured current at specific voltages for 1.0A in the forward light source, and the curve indicated at 52 represents the measured current at specific voltages for 500 mA in the forward light source.

In the event that the overcurrent protection IC in the battery is changed to increase the over current protection current, the selected voltage values can be changed in software or removed. Based on Table 1 and FIG. 7 the unit should control the current to not exceed the over current protection point. The unit will therefore automatically adjust the currents as the voltages drop below the trip voltages, indicated in Table 1.

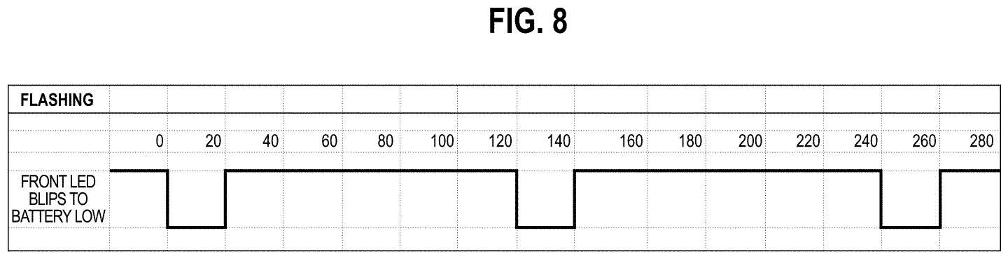

When the current is adjusted due to a lower battery voltage and the forward light source is on, in an embodiment, the forward light source can be configured to blip (flash) 3 times as indicated in FIG. 8 to provide indication to a user. To ensure the user that the lighting device is not faulty, the battery level indication LEDs 26 will change color to indicate that the battery voltage is no longer sufficient to deliver the selected current. When the red indication LED illuminated, the battery 18 is empty and imminent power failure is indicated. When the red indication LED is on, the user will be periodically reminded, for example, every minute, that the power is about to fail with 3 blips (flashes) on the forward light source as indicated in FIG. 8.

To give the effect of a high and a low mode even when the current to the forward light source 16 is restricted due to battery voltage, the lighting device 10 includes firmware to allow the lighting device to switch between acceptable power levels.

For example, referring to Table 1, when the forward light source is in Level 0, the allowed current to the forward light source in high mode will be 1.5A and in low mode 1A. If the battery voltage is below 7.4V, the new high mode will be 1A and the new low mode will be 500 mA for Level 1. At level 2, the unit is only allowed to draw 500mA in forward light source, and thus high and low modes will be 500 mA.

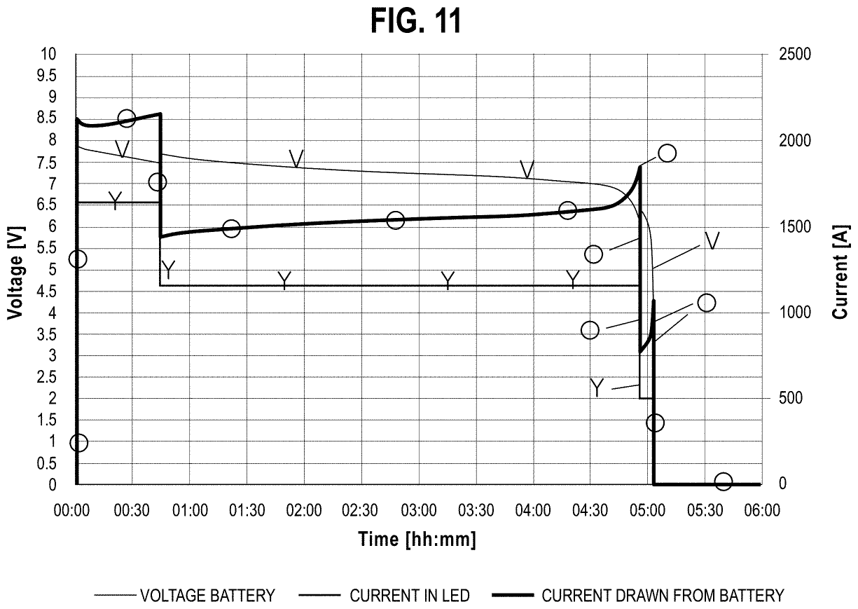

Using this approach, a complete discharge with a full 2S3P battery pack was tested. The voltage trip values in Table 1 were selected. The results are shown in FIG. 11 and indicate the complete battery discharge until the battery protection activates. In FIG. 11, the battery voltage in volts (V) is shown on the left-hand side y-axis and current in milliamps (mA) is shown on the right-hand side y-axis, both versus time in hours and minutes (hr:min) on the x-axis. The battery voltage is shown by the line/curve indicated by Xs, the current in the forward light source is shown by the line/curve indicated by Ys, and the current drawn from the battery is shown by the line/curve indicated by Os.

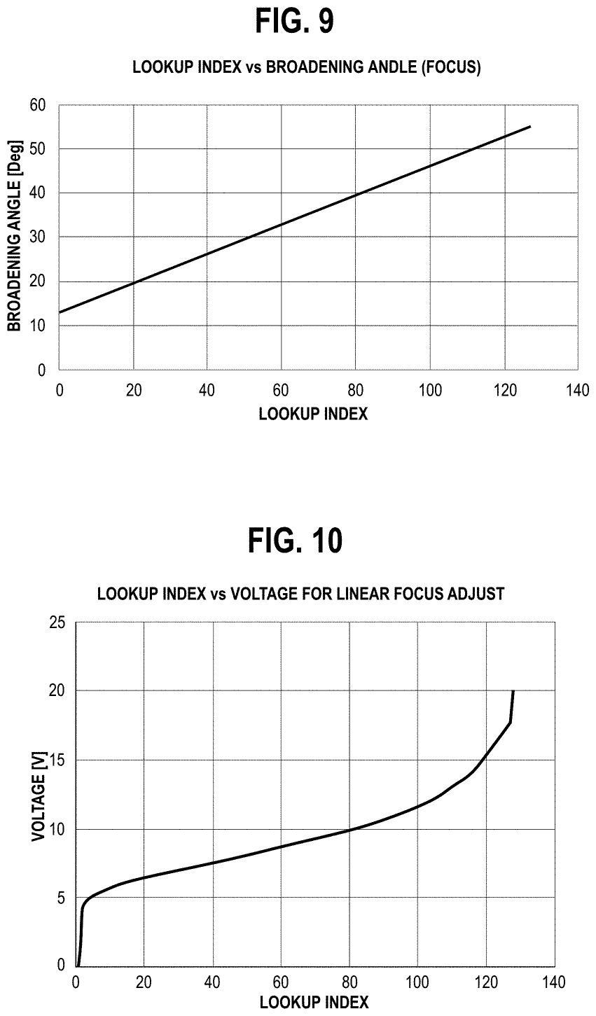

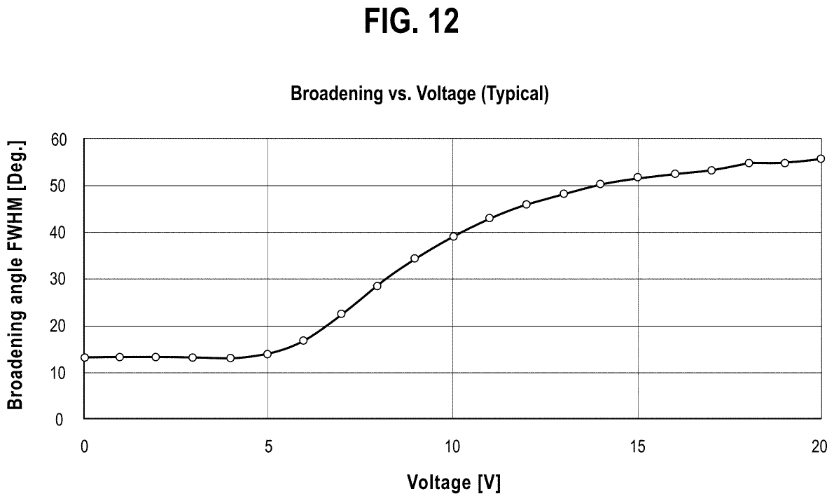

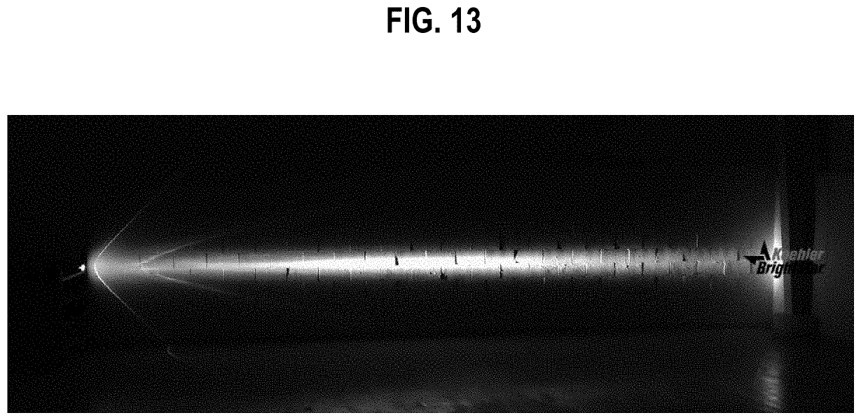

As noted above, the lighting device 10 uses a variable focus lens 14, such as a liquid crystal, controllable lens that permits a beam from the front light source to be dynamically shaped. The beam can be shaped or focused from about 15 degrees to provide narrow spot beam illumination (FIG. 13) to about 55 degrees to provide wide flood beam illumination (FIG. 14). One known variable focus lens has a broadening angle that has a non-linear profile, the profile (broadening angle vs. voltage (supplied to the lens)) is illustrated in FIG. 12. With such a non-liner profile, control of the focus or angle might be difficult. As such, in order to address this difficulty and to obtain a linear broadening profile, a lookup table was established. In a current embodiment, the lookup table was established with 128 steps. FIG. 9 illustrates the plot of lookup index vs. broadening angle or focus and shows a linear relationship from about 15 degrees to about 55 degrees and shows the lookup index from 0 (zero) to 128.

FIG. 10 is an illustration of the lookup index vs. voltage (supplied to the lens) to provide a linear focus adjustment. The adjusted profile is implemented in software within the control circuitry.

In embodiments, the lighting device is provided with temperature sensors/monitoring to protect the hardware. FIG. 6 is a schematic illustration of a typical thermocouple 53 used to sense/monitor temperature. In an embodiment the lighting device has three temperature sensors, and based on the temperatures sensed, the current to the forward light source is controlled. In embodiments, the sensors can be a PCB temperature sensor 54, a forward light source (LED) temperature sensor 56, and a battery temperature sensor 58.

In one method of operation, each of the sensors has three levels that are independent of each other, and each sensor's trip level controls, independently, the maximum allowed current to the forward light source. When, for example, one of the sensors trips (that is, senses above the desired temperature) the light emitted by the forward light source will be visibly adjusted by controlling the current to the light source, in a step-wise manner. In addition, to provide further indication, the voltage level indicator LED can flash. The indicator LED can flash the color of the ongoing battery level (e.g., green, orange, red, see Table 1. If multiple sensors trip, the lighting device will restrict the current to the forward light source based on the highest level (i.e., most restrictive) of any of the sensors. Table 2 identifies examples of the sensed temperatures and the corresponding temperature set points.

TABLE 2
Temperature Sensors, Sensed Character
and Temperature Set Points

| | | Temp. | |
|---|---|---|---|
| Sensor | Sensed character | (° C.) | Action |
| PCB | PCB temperature control | >70 | No action |
| | while discharging (Level | | |
| | 1) | | |
| PCB | PCB temperature control | >80 | No action |
| | while discharging (Level | | |
| | 2) | | |
| PCB | PCB temperature control | >80 | No action |
| | while charging high trip | | |
| | value | | |
| PCB | PCB temperature control | <70 | No action |
| | while charging. Restart | | |
| | value | | |
| Forward | LED temperature control | >70 | Current drop to 90% |
| light | while discharging | | max, sample T after |
| source | (Level 1) | | 60 seconds. Repeat |
| (LED) | | | 10% drop as needed |
| | | | until <70° C. |
| Forward | LED temperature control | >80 | Current drop to 50% |
| light | while discharging (Level | | max, sample T after |
| source | 2) | | 60 seconds. Repeat |
| (LED) | | | 10% drop as needed |
| | | | until <70° C. |
| Battery | Battery temperature | >60 | Discharge cut-off |
| | control while discharging | | to protect battery; |
| | | | resets at 55° C. |
| Battery | Battery temperature | >−20 | Discharge cut-off |
| | control while discharging | | to protect battery |
| | | | if below −20° C.; |
| | | | resets at −15° C. |
| Battery | Battery temperature | >50 | Charging cut-off to |
| | control while charging. | | protect battery; |
| | High trip value | | resets at 45° C. |
| Battery | Battery temperature control | <45 | Battery returns to |
| | while charging. Restart | | charging |
| | value | | |
| Battery | Battery temperature control | <0 | Battery charging cut- |
| | while charging. Low value | | off at 0° C.; resets |
| | | | at 5° C. |

Table 3, below, indicates the allowed current in the forward light source based on the monitored temperatures PCB, forward light source and battery.

TABLE 3
Allowed current in Forward Light Source based
on PCB, LED and Battery Temperatures

| | | Current allowed in forward | |
|---|---|---|---|
| Level | Control | light source | |
| 0 | No temperature control | Restricted by design only | |
| 1 | Some temperature control | ~1 | A |
| 2 | Maximum temperature control | ~500 | mA |

The temperature trip level will only reset when the unit is turned off and on again and all temperature sensors are within the desired range, that is, at Level 0.

In embodiments, the lighting device includes a rear load or light 28. The rear light 28 can be, for example, a red and white light. The rear light can be, for example, a LED. In modes, the rear light can be red/white flashing, a solid red on mode and a solid white on mode.

In embodiments there are three states to battery charging: busy charging, charging complete and an error state. In busy charging, the lighting device battery is charging and the forward light source and rear load will not actuate. The red charging indicator (LED) will indicate that the battery is “busy” charging. This LED will remain illuminated. When charging is complete, the charging complete green indicator (LED) will illuminate and remain illuminated to indicate that the battery is charged to 8.3V±1%.

The lighting device has two error indications. One error indicator indicates a temperature out of range error and the other indicator indicates a USB under voltage error or battery missing error. The battery missing error indicates when a temperature below −45° C. is read from the battery sensor. When the battery is connected, temperatures auto correct and begin charging once the unit heats or cools to within acceptable limits. This is indicated with, for example, an orange flashing indicator (LED). The USB under voltage or battery missing error is, for example, a non-recoverable event and requires user input to resolve and is indicated with, for example, a flashing red indicator (LED). If the USB under voltage recover without input, the battery can return to charging status.

Temperature controls whether the battery will be permitted to charge. The PCB and battery temperature sensors are both used to determine whether a charging condition will be allowed to commence. Each of the sensors has high and restart temperature values that are independent of each other. The battery also has a low temperature. The combined results of the sensors determines whether the battery is allowed to charge. When one of the sensors trip (is above or below the desired temperature), charging will be suspended. Hysteresis has been incorporated for the high temperature values. In embodiments, when temperature is above the trip level, charging will be suspended until the temperature returns to the restart temperature value. Table 4, below sets out the sensor, sensed temperature, and whether charging is allowed or suspended.

TABLE 4
Sensors, Sensed Temperature and Charging Allowed/Suspended

| Sensor | Temperature (° C.) | Charge allowed/suspended |
|---|---|---|
| Battery | <50 | Allowed |
| Battery | >50 | Suspended |
| Battery | <45 | Re-enable, allowed |
| Battery | <0 | Suspended |
| Battery | >5 | Re-enable, allowed |

In embodiments, the lighting device includes a multi-function switch 20 to control operation of the device 10. One suitable switch 20 is a two-way toggle switch. In one example, the switch can control two modes for the forward light source and two modes for the rear light or load. The forward light source is controlled or selected between high or low illumination by multiple forward motion actuations of the switch through off-high-low settings. For example, a first forward switch press activates high mode, a second forward switch press activates low mode and a third forward switch press turns the forward light source off

Focus of the forward light source 16 is adjusted via the variable focus or dynamic lens 14. In one mode of operation, the lens 14 can be adjusted with a long press of the switch 20. When the forward light source is illuminated, after the switch is released, a press and hold of the switch for a specified period of time (for example, about 650 ms) activates the lens focus adjust. When the switch is released, focusing will stop adjusting and remain at selected focus. A user can reactivate focus adjust with another press and hold for the specified period of time. Short blips, for example, 20 ms blips, can indicate to the user that the maximum or minimum focus has been reached. To increase the focus (no distortion through the lens) a long forward switch button press can be is used. To decrease the focus (increase distortion through the lens) a long backward switch press can be used.

The switch 20 can also be used to control the rear light or load 28. In a mode of operation, a first backward press of the switch and actuate flashing of the rear light, a second backward press of the switch can actuate a steady on of the rear light and a third backward press of the switch can turn off the rear light. Other modes of operation of the forward light source and rear light will be recognized by those skilled in the art.

The advantages of the present lighting device 10 will be appreciated in that the lighting device 10 has a luminous intensity of about 450,000 candela, a beam distance of over 4,400 feet (over 1300 meters), and the ability to cast a beam to the top of a building over 300 stories. At 25 feet the lighting device in flood beam mode can produce sufficient light to illuminate a ladder truck in light. The lighting device has a run time of about 4 hours and a charge time of about 4 hours. The variable focus spot to flood is about a 1.5 degree to about 50 degree beam angle.

Features from any one of the embodiments described above may be implemented in, combined or used together with, or replace features from any of the other embodiments described above. That is, the various features from any of the embodiments above are usable together with the other embodiments described herein.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular. In addition, it is understood that terminology referring to orientation of various components, such as “upper” or “lower” is used for the purposes of example only, and does not limit the subject matter of the present disclosure to a particular orientation.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

What is claimed is:

1. A lighting device comprising:
a housing;
a power supply;
a first light source;
a variable focus lens adapted to vary the focus of light from the first light source;
a switch; and
a controller having circuitry,
wherein the circuitry is adapted to control the current to the first light source based upon a voltage of the power supply, and is adapted to control variability of the variable focus lens.

2. The lighting device of claim 1, wherein the first light source is a forward light source and wherein the forward light source is a LED.

3. The lighting device of claim 1, wherein the power source is a portable power supply.

4. The lighting device of claim 3, wherein the portable power source is a rechargeable power supply.

5. The lighting device of claim 4, wherein the rechargeable power supply is a battery.

6. The lighting device of claim 1 further including one or more second light sources, wherein the one or more second light sources are rear lights.

7. The lighting device of claim 1, wherein the variable focus lens shapes a beam from the light source between about 15 degrees and 55 degrees.

8. The lighting device of claim 7, wherein the variable focus lens is a liquid crystal controllable lens.

9. The lighting device of claim 7, wherein the variable focus lens has a non-linear broadening angle profile.

10. The lighting device of claim 9, wherein the control circuitry is adapted to convert the non-linear broadening angle profile to a linear broadening angle profile.

11. The lighting device of claim 1, wherein the power source has a peak voltage of greater than about 7.4V and wherein when a voltage from the power source is between about 7.4V and 6V, the circuity regulates current from the power source to forward light source to about 1A, and when the voltage from the power source is less than about 6V, the circuity regulates the current from the power source to the forward light source to about 500 mA.

12. The lighting device of claim 10, wherein the lighting device further includes a power source level indicator and wherein when the voltage is greater than about 7.4V, the power source level indicator indicates full power, wherein when the voltage is between about 7.4V and 6V, the power source level indicator indicates mid-level power and wherein when the voltage is less than about 6V, the power source level indicator indicates low power.

13. The lighting device of claim 1, further including one or more temperature sensors.

14. The lighting device of claim 13, wherein the temperature sensors include a PCB temperature sensor and/or a forward light source temperature sensor and/or a power source temperature sensor.

15. The lighting device of claim 14, wherein the temperature sensors include a PCB sensor, a forward light source temperature sensor and a power source temperature sensor.

16. The lighting device of claim 1 wherein, the switch controls power to the first light source and controls variability of the variable focus lens.

17. The lighting device of claim 11, further including a forward light source temperature sensor, and wherein when the current to the forward light source is about 1A and the forward light source temperature sensor senses a temperature of greater than about 70° C., current to the forward light source is reduced to 90 percent.

18. The lighting device of claim 17, wherein when the current to the forward light source is about 500 mA and the forward light source temperature sensor senses a temperature of greater than about 80° C., current to the forward light source is reduced to 50 percent.

19. The lighting device of claim 14 wherein the power source is a rechargeable battery and wherein charging of the battery is suspended when the power source temperature sensor senses a temperature greater than about 50° C.

20. The lighting device of claim 19, wherein when battery charging is suspended as a result of the battery temperature sensor sensing a temperature greater than about 50° C., charging resumes when the battery temperature sensor senses a temperature less than about 45° C.
